(19) United States
(12) Patent Application Publication
(10) Pub. No.: US 2010/0221393 A1
(43) Pub. Date: Sep. 2, 2010

(54) Resealable, Reusable Plastic Storage Container and Lid With Gas-Permeable Membranes for Modified Storage of Food and Perishables

(76) Inventors: Loong Keng Lim, Vancouver (CA); Kee Eng Lee, Singapore (SG)

Correspondence Address: DILWORTH & BARRESE, LLP, 1000 WOODBURY ROAD, SUITE 405, WOODBURY, NY, 11797, US

(21) Appl. No.: 12/225,283

(22) PCT Filed: Mar. 21, 2006
(86) PCT No.: PCT/SG2006/000054

§ 371 Date: Sep. 17, 2008

(51) Int. Cl. A23B 7/148; B65D 81/18; B65D 81/24; B65D 51/00; B65D 81/26

(52) U.S. Cl. 426/124; 426/106; 428/35.7; 220/200; 206/204

(57) ABSTRACT

A system and reusable plastic container for preserving the quality of a range of fruits and vegetables are provided. The container independently maintains modified atmospheres and relative humidity within the range of 1% to 50% carbon dioxide plus 1% to 15% oxygen and relative humidity of 75% RH and 100% RH. For produce highly susceptible to mould, yeast and/or bacterial growth at RH of 75% to 80% will result in optimum quality retention. The container includes a plastic body, plastic lid and a gas permeable film membrane hermetically sealed between the lid and the container. The plastic body and lid can be polyamide (nylon 6, 11, 12, or 66 and blends thereof), polycarbonate, polyethylene, polyethyleneterepthalate, polypropylene, polystyrene, polyvinylchloride, and mixtures thereof. The lid can be macro-perforated for a three piece application or micro-perforated for a two piece application. The film membranes can have different oxygen and carbon dioxide permeability rates for specific package volumes and specific produce respirations.

### FIELD OF THE INVENTION

This invention relates to a novel process and reusable plastic storage container for the modified atmosphere preservation of fresh fruits and vegetables. More particularly the invention pertains to the preserving of the food integrity and food safety in a sealed container which permits the exchange of oxygen carbon dioxide and water vapour to maintain optimum internal relative humidity, high levels of carbon dioxide and low levels of oxygen for optimum preservation of foods at refrigerated temperatures for extended storage periods.

### BACKGROUND OF THE INVENTION

Fresh ripe fruits and vegetables and other foods are often purchased by consumers for intended use over a period of up to 7 days. Whole fresh fruits and vegetables are often peeled, cored, de-seeded and segmented in the home or in food service establishments prior to consumption. Often the available storage facilities are not adequate to provide proper environments to maintain the optimum quality of the food in a food safe environment for periods more than one or two days.

Reusable storage containers are often used to place prepared fruits and vegetables to maintain the quality and freshness of the product. Most of these containers serve to increase the humidity of the product to prevent desiccation of the product. While this application has a short term benefit, respiration of the product generates moisture which develops a saturated environment leading to the growth of bacteria, yeast and moulds which affect product quality and food safety. In addition, excessively high moisture levels lead to softening of the product and rapid deterioration of quality.

Most fresh fruits, vegetables maintain quality in environments that have relative humidity maintained between 84% RH and 94% RH. However, for those products highly susceptible to mould, yeast and/or bacterial growth (i.e. bell peppers, mushrooms, berries etc.) a relative humidity of 75% to 80% will result in optimum quality retention.

Modification of the gas composition in the atmosphere within a package around the food can prolong the storage life of the fruit, vegetable or other food products. Modified Atmosphere Packaging (MAP) is an application which uses the respiring food to reduce the oxygen level and accumulate the carbon dioxide levels within a package. The lower oxygen and higher carbon dioxide atmosphere slows the respiration rate and quality loss of the food and suppresses microbial vegetative growth and spore germination leading to product quality loss (Powrie and Skura, “Modified Atmosphere Packaging of Fruits and Vegetables”, Ellis Horwood, 1991, pages 169-245; Zagory. “Modified Atmosphere Packaging”, A. Brody, K. Marsh Eds. The Wiley Encyclopaedia of Packaging 1023 pages).

There are many types of reusable food storage containers in use today. However, the lid and the container materials are of materials and thickness that prevent the transmission of oxygen, carbon dioxide and water vapour through the materials. For plastic container applications, the transmission of carbon dioxide, oxygen and water vapour occurs through the lid to container rim seal and is unregulated. The exchange of these gases will depend upon the tightness of the seal between the two surfaces.

Most current plastic container applications do not provide a hermetic seal at the lid to container rim surface. In these applications, oxygen and carbon dioxide diffuses freely between the interior and exterior of the container through the lid-container interface and establishes equilibrium with normal air (less than 1% carbon dioxide and 17%-20% oxygen). In these applications the fresh food does not benefit from internal modified atmospheres. However, the non-hermetic seal in the plastic container does impede the exchange of water vapour and hence provides high relative humidity within the container.

Some recent container designs use tabs or wings to secure the lid to the container. These tabs or wings which secure the lid to the container may create hermetic seals if the lid to container rim design and/or a gasket is used provide an air tight seal. The lid to container seal needs to be hermetic for the present application as gas exchange between the interior of the container and the external environment is regulated by either the type of container material or the selected films contained within the modified lid structure.

A novel functional reusable food storage container for home and institutional use can impart significant benefits in maintaining food quality, extending the usable life of foods in the home and institutions and providing greater consumer confidence in food safety.

### SUMMARY OF THE INVENTION

This invention relates to a novel application which provides for simultaneous control and regulation of water vapour transmission and oxygen and carbon dioxide transmission for food products held at refrigerated temperatures for extended storage periods of 5 to 20 days.

The objectives of this invention, which are to be achieved from the design, composition and implementation of this system, are:
1. retention of ready-to-eat quality of prepeeled, deseeded, trimmed chunked, sliced, cubed or other prepared fruit or vegetables;
2. inhibition of mould, yeast and bacterial development on ready-to-eat food;
3. inhibition of off-flavors that develop from yeast, mould or bacteria growth and/or physiological senescent processes.

The invention consists of the novel container design and application inclusive of the following:
1. preparing the fruit or vegetable by washing, sanitizing, peeling, trimming and/or marinating the product;
2. placing the product in a custom designed container consisting of an open-box structure with a continuous inverted upper rim that represents a contact surface with two to four opposed receptacles for latch contact. The lid consists of two pieces:
   i/ a micro or macro-perforated panel that engages a film with selected permeability for oxygen and carbon dioxide transmission which then form a hermetic seal with the upper rim of the container portion or alternatively;
   ii/ the gas transmission film can be used either from roll stock or pre-cut film, but alternatively could be film encircled by a plastic frame which compresses and hermetically seals to the lid panel and the inverted upper rim of the container. Alternatively, the film may be selected as a high barrier film to the transmission of oxygen and carbon dioxide with a permeable rubber/plastic gasket applied to the plastic frame for optimal gas transmission. In this latter application the film may be constructed of polyamide to provide enhanced water vapour transmission properties.
   The lid panel has two or four opposed latches which rotate to compress the lid and film to form a hermetic seal with the rim of the container.
3. The container body may be constituted from a range of plastic materials including but not limited to polyamide (nylon 6, 66, 11, or 12 and blends thereof) polycarbonate, polyethylene, polyethyleneterepthalate, polypropylene, polystyrene, polyvinylchloride, and mixtures thereof.
4. The lid may be constituted from a range of plastic materials including but not limited to polyamide (nylon 6, 11, 12 or 66 and blends thereof), polycarbonate, polyethylene, polyethyleneterepthalate, polypropylene, polystyrene, polyvinylchloride, and mixtures thereof.
5. The differentially permeable film membrane hermetically sealed between the lid and the container may be constituted from a range of plastic materials including but not limited to: polyamide (high barrier to oxygen and carbon dioxide, permeable to water vapour), polyethylene, polypropylene, polyvinylchloride and mixtures and/or laminates thereof.

The container and top for holding the fresh food should have semi-rigid walls with high oxygen and carbon dioxide barrier properties. The film properties should be chosen from one of four permeability ranges specific for food type:
1. Category 1:
   High Barrier Film:
   Oxygen transmission rates of: 100 to 1500 cm³ per m² per 24 hours at 25° C. at 1 atm
   Carbon dioxide transmission rates of: 300 to 4500 cm³ per m² per 24 hours at 25° C. at 1 atm.
2. Category 2:
   Medium Barrier Film:
   Oxygen transmission rates of: 1500 to 5000 cm³ per m² per 24 hours at 25° C. at 1 atm
   Carbon dioxide transmission rates of: 4500 to 15,000 cm³ per m² per 24 hours at 25° C. at 1 atm.
3. Category 3:
   Low Barrier (High Permeability) Film:
   Oxygen transmission rates of: 25,000+ over cm³ per m² per 24 hours at 25° C. at 1 atm
   Carbon dioxide transmission rates of: 75,000+ cm³ per m² per 24 hours at 25° C. at 1 atm.

The films for the three categories ideally are color coded for simplicity of application to a particular food group. The color coding may be applied to the film or the plastic frame. As examples, green color coding of Category 1 would apply to green leaf salads ((low to medium respiration rates), red color coding of Category 2 would apply to fruit pieces (intermediate respiration rates), and white coding of Category 3 would apply to mushrooms (high respirations rates).

The film selections must allow carbon dioxide transmit through the film at rates 3 to 4 times the oxygen transmission rate and therefore have a carbon dioxide:oxygen diffusion ratio of 1:3 to 4. For the example which employs micro-perforations the oxygen:carbon dioxide diffusion ratio will be 1 to 1.0 to 1.5.

The container top and bottom materials can to maintain internal humidity in the range of 75% RH to 85% by the use of polyamide materials and thickness of construction. Alternatively, the gas regulation film can be constructed of polyamide for enhanced water vapour exchange and oxygen and carbon dioxide exchange provided by a single 50 to 90 micron perforation either in the lid to container gasket or the film itself.

Prior to sealing the package, air may be removed from the package by vacuum.

The sealed package of respiring fresh food can contain a ratio mass (grams) to total package volume (cm³) of between 0.3 to 0.6. The headspace gas composition of the sealed package can be between 1 and 50% carbon dioxide and 0.5% to 15% oxygen with internal relative humidity of 75% RH to 100% RH.

### BRIEF DESCRIPTION OF THE DRAWINGS

The disclosed containers are described diagrammatically in the following drawings wherein:

FIG. 1 provides a view of the film, lid and container where the film is selected to have specific oxygen transmission properties;

FIG. 2 provides a view of the film, lid and container where the film is selected to have low oxygen and carbon dioxide transmission properties but high water vapour transmission properties and the gas exchange is regulated by a micro-perforation placed either in the film or gasket.

The drawings are not necessarily to scale and the embodiments are sometimes illustrated by graphic symbols, phantom lines, diagrammatic representations and fragmentary views. In certain instances, details which are not necessary for an understanding of the disclosed containers or which may render other details difficult to perceive may have been omitted. It should be understood, of course, that the disclosure is not necessarily limited to the particular embodiments illustrated herein.

### DETAILED DESCRIPTION OF THE PREFERRED EMBODIMENTS

Throughout the following description, specific details are set forth in order to provide a more thorough understanding of the invention. However, the invention may be practised without these particulars. In other instances, well know elements have not been shown or described in detail to avoid unnecessarily obscuring the invention. Accordingly, the specification is to be regarded in an illustrative, rather than a restrictive, sense.

This invention provides a novel packaging application involving the preparation of washed, sanitized, peeled, deseeded and pre-cut fruits and vegetables followed by modified atmosphere packaging of the product for ready-to-eat consumption at a later time. The fresh product continues to respire in the sealed container and consumes oxygen and releases carbon dioxide into the chamber environment and are subject to modified atmosphere packaging (MAP). The natural processes provide reduced oxygen content with increased carbon dioxide content. This state provides for reduction of product respiration, inhibition of microbiological growth and spore germination and inhibition of senescence promoting ethylene action thereby maintaining product ripeness and retarding deterioration of the product.

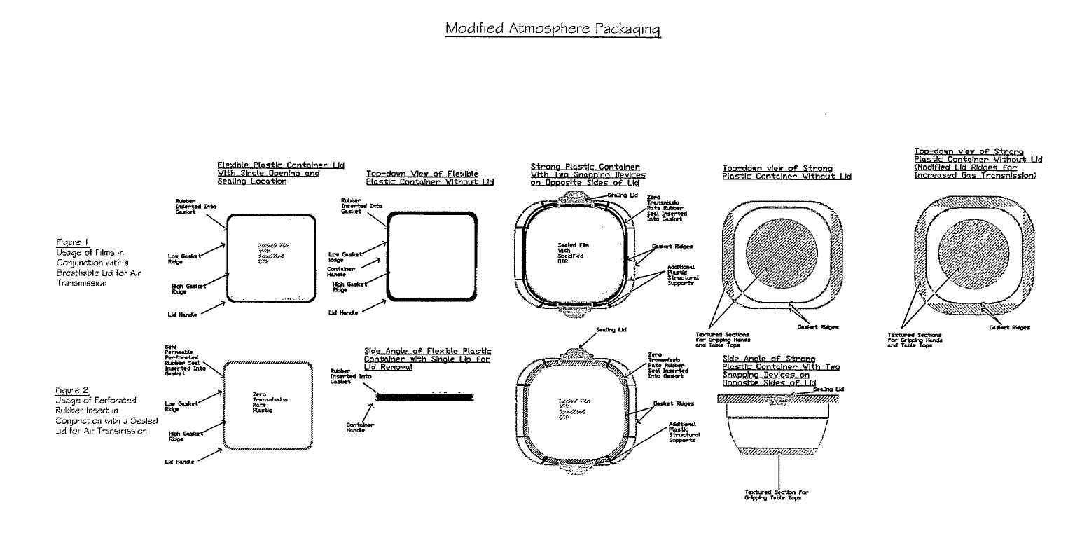

The functional, reusable modified atmosphere storage container, lid and film is illustrated in FIGS. 1 and 2. The apparatus provides for the simultaneous or independent regulation of oxygen, carbon dioxide and water vapour transmission between the interior and exterior of the sealed package and the ambient storage atmosphere. Oxygen and carbon dioxide transmission is regulated by a range of specialized films with specific oxygen and carbon dioxide transmission rates and/or by the use of micro-perforations in the lid the container seal gasket or micro-perforations in the film itself. Generally if micro-perforations are used the total surface area would be in the range of 50 to 200 microns and can be customized for specific product categories. The lid is perforated with either micro-perforations or macro-perforations with lid perforation surface area up to 1% of the total lid surface area.

According to the invention, prepared optimum maturity fruits and vegetables are placed into the container and sealed in the plastic packages (MAP packages) with the appropriate gas transmission rates to ensure the attainment of high carbon dioxide levels (5% to 20%) and low oxygen levels (1.5% to 5%) in the headspace of the container after 7 days of storage at 5 C. Films are provided for specific products and volumes to ensure that oxygen levels do not fall below 1% where anaerobic respiration can affect product quality and food safety may become an issue.

A minimum of three film or perforation options are provided for specific categories of fruit and vegetables. Each film option will be color coded for easy identification. Specifically, the film oxygen transmission ranges for ratio mass (grams) to total package volume (cm³) of between 0.3 to 0.6 would be applicable as:
1. Category 1:
   High Barrier Film:
   Oxygen transmission rates of: 100 to 1500 cm³ per m² per 24 hours at 25° C. at 1 atm
   Carbon dioxide transmission rates of: 300 to 4500 cm³ per m² per 24 hours at 25° C. at 1 atm.
Sample product applications: Baby carrots, beets and other root crops; fresh cut salads.
2. Category 2:
   Medium Barrier Film:
   Oxygen transmission rates of: 1500 to 5000 cm³ per m² per 24 hours at 25° C. at 1 atm
   Carbon dioxide transmission rates of: 4500 to 15,000 cm³ per m² per 24 hours at 25° C. at 1 atm.
Sample product applications: Fruits such as cantaloupe, honey dew, tomatoes, apple, pears, cherries, grapes, peaches, nectarines, kiwi, strawberries, tomatoes, cucumbers (in general citrus, pome and drupe fruits, berries and greenhouse crops).
4. Category 3:
   Low Barrier (High Permeability) Film:
   Oxygen transmission rates of: 25,000+ over cm³ per m² per 24 hours at 25° C. at 1 atm
   Carbon dioxide transmission rates of: 75,000+ cm³ per m² per 24 hours at 25° C. at 1 atm.
Sample product applications: Mushrooms, asparagus.

The novel apparatus provides additional maintenance of food product quality with options to regulate the relative humidity within the sealed package through the selection of lid, container and film materials. Fabrication of the film, container and/or lid from a range of polyamide materials (water vapor absorption/permeabilities of 1.0 to 2.5 g-mm per m²-day at 75% to 100% relative humidity) provides the ability to absorb moisture and regulate relative humidity levels within the sealed package. Maintenance of internal relative humidity levels at approximately 75% RH to 85% RH maintains product quality by removing residual surface water from the product, providing slight moisture reduction of the product, removal of water vapour generated from product respiration and maintain a relative humidity level that suppresses microbial vegetative growth and spore germination (below 80% RH). Pre-cut salads have been shown to double the effective shelf life if the product is stored without residual moisture after washing and dried to original of −1% (wt/wt) of its original weight.

### Example 1

The process for preparation and preservation of perishable kiwi fruit using the invention, involves the following:
1. Ready-to-eat firm mature ripe kiwi fruit (firmness of 1 to 3 kgf) that are free of obvious decay are selected, washed with soap and water (or 100 ppm chlorine if available) and dried with a paper towel or air;
2. Kiwi fruit are peeled with a sharp knife and sliced as halves, segments or slices of desired size;
3. Approximately 200 g of prepared kiwi fruit (approximately 2 peeled kiwi fruit) are placed a 500 mL container and lid constructed of polyethyleneterepthalate;
4. The kiwi fruit were sealed in the package (silicon gaskets) with a plastic film with an oxygen transmission rate of 3000 cm³ per m² per 24 hours at 25° C. at 1 atm and stored at 5° C. for 15 days (MAP).

The quality of the MAP kiwi fruit compared to non-MAP controls (consisting of identical fruit in perforated clamshells) was superior after three days in storage. Control fruit were noticeably water logged, with a translucent appearance, dull grey core area, soft flesh texture and loss of characteristic kiwi flavour. Kiwi fruit placed in clamshells were rated as unacceptable for consumption after day 3 of storage by a 3 member trained sensory panel.

Kiwifruit stored in the MAP container were rated by the sensory panel as excellent on day 7 of storage and as acceptable at day 15. Fruit pieces were bright green and opaque with texture equivalent to the texture at day 0. Characteristic kiwi flavour was maintained throughout the 15 days storage period without noticeable off-flavors (ethanol and acetaldehyde) found in the control fruit.

### Example 2

The process for preparation and preservation of fragile baby leaf lettuce salad using the invention, involves the following:
1. Baby leaf lettuce mixtures consisting of red romaine, green oak, red oak, green leaf, lolla rossa, red leaf, radicchio, little gem, tango and green romaine was commercially prepared and packed in a MAP bag with oxygen transmission rate 1800 cm³ per m² per 24 hours at 25° C. at 1 atm;
2. With six day of shelf life in the package and with 6 days remaining to code date (coded for 12 days of shelf life at 5° C.), the bag was opened and 100 grams of the baby lettuce blend repackaged in either in a 500 mL ventilated clamshell (ambient atmosphere) or the invention consisting of container, lid and film constructed from a polyamide blend.
3. A 60 micron perforation was inserted in the film to provide an oxygen and carbon dioxide transmission rate of approximately 2500 cm³ per m² per 24 hours at 25° C. at 1 atm and the package sealed with silicon gaskets and stored at 5° C. for periods of 3, 6, 9 and 12 days;

Baby leaf product stored in the ventilated clamshells demonstrated significant wilting of surface product after three days of storage and was accompanied by observable browning of some of the components, most notably the radicchio and other red components. While the product was rated as marginally acceptable at day 6, the product rated as unacceptable for consumption by day 6 of storage. At day 6 more than 60% of the leaf product was either wilted or discoloured from high oxygen levels encountered in the clamshell. By day 9, a significant off-odor was evident with product breaking down due to slime mould (erwinia spp., pseudomonas spp).

Baby leaf product stored in the MAP container after 12 days of storage was rated as 4 of a full scale of 5 (5 being excellent and 3 deemed to be marginally acceptable). Browning and wilting of the lettuce was not evident. After 12 days of storage, the MAP product was scored as 3.5 and found to be acceptable for consumption. No off odors or evidence of mould or decay were identified.

As will be apparent to those skilled in the art with respect to the forgoing disclosures, many alterations and modifications are possible in the practice of this invention without departing from the spirit or scope thereof. Accordingly, the scope of the invention is to be construed in accordance with the substance defined in the following claims.

1-7. (canceled)

8. A system for the maintenance of quality and preservation of food using modified atmospheres containing 1% to 50% carbon dioxide and 1% to 15% oxygen.

9. A system and resealable, reusable plastic container according to claim 8 for preserving fresh ready-to-eat fruits and vegetables by packaging peeled, deseeded and cut pieces in a modified atmosphere package between 1% and 15% oxygen and 1% and 20% carbon dioxide at relative humidity between 50% RH and 94% RH.

10. A system of claim 9 which independently controls modified atmospheres and humidity within a container.

11. A resealable, reusable plastic container that can be designed in various shapes, including but not limited to round, square, rectangular or oval and can contain two or three pieces including:
a) A container body constitutable from a range of plastic materials including but not limited to polyamide (nylon 6, 66, 11, or 12 and blends thereof), polycarbonate, polyethylene, polyethyleneterepthalate, polypropylene, polystyrene, polyvinylchloride, and mixtures thereof;
b) A lid constitutable from a range of plastic materials including but not limited to polyamide (nylon 6, 11, 12 or 66 and blends thereof), polycarbonate, polyethylene, polyethyleneterepthalate, polypropylene, polystyrene, polyvinylchloride, and mixtures thereof and which can either be macro-perforated for a three piece application or micro-perforated for a two piece application; and
c) A differentially permeable film membrane hermetically sealed between the lid and container and constitutable from a range of plastic materials including but not limited to: polyamide (high barrier to oxygen and carbon dioxide, permeable to water vapour), polyethylene, polypropylene, polyvinylchloride and mixtures and/or laminates thereof.

12. A system of claim 8 which provides a selection of film options with oxygen and carbon dioxide permeability designed for specific package volumes and produce respiration and composable of
Category 1:
High Barrier Film:
Oxygen transmission rates of: 100 to 1500 cm³ per m² per 24 hours at 25° C. at 1 atm
Carbon dioxide transmission rates of: 300 to 4500 cm³ per m² per 24 hours at 25° C. at 1 atm.
Sample product applications: Baby carrots, beets and other root crops; fresh cut salads;
Category 2:
Medium Barrier Film:
Oxygen transmission rates of: 1500 to 5000 cm³ per m² per 24 hours at 25° C. at 1 atm
Carbon dioxide transmission rates of: 4500 to 15,000 cm³ per m² per 24 hours at 25° C. at 1 atm.
Sample product applications: Fruits such as cantaloupe, honey dew, tomatoes, apple, pears, cherries, grapes, peaches, nectarines, kiwi, strawberries, tomatoes, cucumbers (in general citrus, pome and drupe fruits, berries and greenhouse crops); and
Category 3:
Low Barrier (High Permeability) Film:
Oxygen transmission rates of: 25,000+ over cm³ per m² per 24 hours at 25° C. at 1 atm
Carbon dioxide transmission rates of: 75,000+ cm³ per m² per 24 hours at 25° C. at 1 atm.
Sample product applications: Mushrooms, asparagus.

13. A system that can regulate relative humidity within a container within a range of 50% to 94%, preferably between 75% and 85% for some foods by removing moisture from the food and the moisture generated from respiration by constructing the lid, container or film of polyamide materials with water absorption/transmission properties within the range of 5.0 to 90 g-mm per m²-day at 75% to 94% relative humidity, the resulting relative humidity suppressing product decay due to micro-organisms.

14. A system of claim 13 where the sealed package of respiring fresh food can contain a ratio mass (grams) to total package volume (cm³) of between 0.3 to 0.6, and the headspace gas composition of the sealed package can be between 1 and 50% carbon dioxide and 1% to 15% oxygen with internal relative humidity of 50% RH to 94% RH.

15. A system that can regulate relative humidities within a sealed container by various materials, thicknesses and the manipulation of relative humidity gradients between the interior of the container and the external refrigerated environment, the gradient range is between 20% RH and 70% RH.
